(19) United States
(12) Patent Application Publication
(10) Pub. No.: US 2013/0130124 A1
(43) Pub. Date: May 23, 2013

(54) POROUS METAL BODY, METHOD FOR PRODUCING THE SAME, AND BATTERY USING THE SAME

(71) Applicants: Atsushi Fukunaga, Osaka-shi (JP); Shinji Inazawa, Osaka-shi (JP); Masatoshi Majima, Osaka-shi (JP); Atsushi Yamaguchi, Osaka-shi (JP); Koji Nitta, Osaka-shi (JP); Shoichiro Sakai, Osaka-shi (JP)

(72) Inventors: Atsushi Fukunaga, Osaka-shi (JP); Shinji Inazawa, Osaka-shi (JP); Masatoshi Majima, Osaka-shi (JP); Atsushi Yamaguchi, Osaka-shi (JP); Koji Nitta, Osaka-shi (JP); Shoichiro Sakai, Osaka-shi (JP)

(73) Assignee: SUMITOMO ELECTRIC INDUSTRIES, LTD., Osaka-shi, Osaka (JP)

(21) Appl. No.: 13/812,546

(22) PCT Filed: Jul. 25, 2011
(86) PCT No.: PCT/JP2011/066855

§ 371 Date: Jan. 28, 2013

(30) Foreign Application Priority Data
Aug. 2, 2010 (JP) 2010-173322

(51) Int. Cl. H01M 4/66; H01M 4/04

(52) U.S. Cl. CPC H01M 4/661; H01M 4/0402
USPC 429/242; 427/123

(57) ABSTRACT

A main object is to produce a porous metal body that can be used as a battery electrode, in particular, that can be used as a negative electrode of a molten-salt battery using sodium. The porous metal body includes a hollow metal skeleton composed of a metal layer containing nickel or copper as a main component, and an aluminum covering layer that covers at least an outer surface of the metal skeleton. The porous metal body further includes a tin covering layer that covers the aluminum covering layer, and is used as a battery electrode. Preferably, the porous metal body has continuous pores due to a three-dimensional network structure thereof, and has a porosity of 90% or more.

### TECHNICAL FIELD

The present invention relates to a porous metal body having an aluminum covering layer on a surface thereof, the aluminum covering layer being formed by aluminum plating, and a battery in which the porous metal body is used as an electrode, and, in particular, to a porous aluminum body suitable for use as a battery electrode and a method for producing the same.

### BACKGROUND ART

Porous metal bodies having a three-dimensional network structure are used in various applications such as filtration filters, catalyst supports, and battery electrodes. For example, Celmet (manufactured by Sumitomo Electric Industries, Ltd.: registered trademark: hereinafter, a porous metal body having this structure is simply referred to as “Celmet”) composed of nickel is used as an electrode material of a battery such as a nickel-metal hydride battery or a nickel-cadmium battery. Celmet is a porous metal body having continuous pores, and has a feature that the porosity thereof is higher (90% or more) than that of other porous bodies such as metal nonwoven fabrics. Celmet is produced by forming a nickel layer on a surface of a skeleton of a porous resin body having continuous pores, such as urethane foam, then decomposing the porous resin body by heat treatment, and subjecting nickel to a reduction treatment. The nickel layer is formed by performing a conductivity-imparting treatment by coating the surface of the skeleton of the porous resin body with a carbon powder or the like, and then depositing nickel by electroplating.

Aluminum is used as an electrode material in some types of batteries. For example, an aluminum foil whose surface is coated with an active material such as lithium cobalt oxide is used as a positive electrode of a lithium-ion battery. The utilization ratio of an active material per unit area can be improved by processing aluminum into a porous body to increase the surface area and to fill the interior of aluminum with the active material. However, a porous aluminum body that can be practically used has not been known.

As for a method for producing a porous aluminum body, PTL 1 describes a method for forming a metallic aluminum layer of 2 to 20 μm on a plastic base having inner continuous spaces and a three-dimensional network shape by performing an aluminum vapor deposition process by an arc ion-plating method. PTL 2 describes a method for obtaining a porous metal body by forming a coating film of a metal (such as copper), which will form a eutectic alloy at a temperature equal to or lower than the melting point of aluminum, on a skeleton of a resin foam body having a three-dimensional network structure, then applying an aluminum paste thereto, and conducting heat treatment at a temperature of 550° C. or higher and 750° C. or lower in a non-oxidizing atmosphere to eliminate an organic component (resin foam) and sinter an aluminum powder.

### CITATION LIST

### Patent Literature

PTL 1: Japanese Patent No. 3413662
PTL 2: Japanese Unexamined Patent Application Publication No. 8-170126

### SUMMARY OF INVENTION

### Technical Problem

PTL 1 describes that a porous aluminum body having a thickness of 2 to 20 μm is obtained by the method disclosed therein. However, it is difficult to produce a porous aluminum body having a large area because a gas phase method is employed, and it is also difficult to form a layer that is uniform even in the interior of the base depending on the thickness and the porosity of the base. In addition, this method has problems in that, for example, the rate of formation of the aluminum layer is low and the production cost increases because the equipment is expensive. According to the method disclosed in PTL 2, a layer that forms a eutectic alloy with aluminum is formed and thus an aluminum layer having a high purity cannot be formed.

The inventors of the present application have been developing a method for producing a porous aluminum body that can be used as a battery electrode. Through the process, the inventors of the present invention found a problem in the case where an existing method for producing Celmet composed of nickel or the like is applied to aluminum. In the existing method for producing Celmet, a metal layer is formed on a surface of a porous resin body by plating, roasting is then conducted at a high temperature to remove the porous resin body, thus producing a porous metal body having a skeleton composed of only a metal. Although the surface of the metal is oxidized in this process, a metal surface is formed by conducting a reduction treatment of the oxidized surface after the roasting. However, in the case where aluminum is used as a metal and a similar step is performed, the resulting porous body cannot be used as an electrode material of a battery or the like because an aluminum surface which has been once oxidized cannot be easily reduced. The invention of the present application has been conceived as means for solving the problem caused by performing such a roasting step.

The inventors of the present invention have been developing, as a battery which is an application of such an electrode, a molten-salt battery containing sodium as an active material. In such a battery, the known Celmet composed of nickel or copper cannot be used as a negative electrode. This is because a metal such as nickel forms an alloy with sodium or dissolves in a molten salt, thereby degrading the battery performance. To address this problem, a porous metal body whose surface has high aluminum purity has been desired.

Accordingly, a main object of the present invention is to provide a porous metal body that can be used as a battery electrode, in particular, a porous metal body suitable for use as a negative electrode of a molten-salt battery using sodium.

### Solution to Problem

According to a first embodiment of the present invention, a porous metal body includes a hollow metal skeleton composed of a metal layer containing nickel or copper as a main component and having a thickness of 4.0 μm or more, and an aluminum covering layer that covers at least an outer surface of the metal skeleton (Claim 1). The porous metal body preferably has continuous pores due to the skeleton having a three-dimensional network structure, and a porosity of 90% or more (Claim 2). Furthermore, the aluminum covering layer is preferably provided on an inner surface of the hollow metal skeleton (Claim 3).

This porous metal body has a specific structure including a relatively strong skeleton structure which is composed of nickel or copper and the surface of which is covered with aluminum. Therefore, the porous metal body can be used in applications in which properties specific to aluminum, for example, a property that degradation is suppressed by the formation of an oxidized film on the surface and a property that the surface has a high electrical conductivity, are utilized. Furthermore, the porous metal body can also be used in applications in which exposure of nickel or copper is not preferable. When nickel is contained in the skeleton, characteristics of nickel functioning as a magnetic material can be utilized. When copper is contained in the skeleton, a porous body having a very high electrical conductivity can be obtained.

When the porous metal body is used as a battery electrode material, the aluminum covering layer preferably has a thickness of 1.0 μm or more and 3.0 μm or less (Claim 4). By covering the porous metal body with aluminum, it is possible to prevent degradation of the battery performance due to dissolution of nickel or copper in an electrolyte. Furthermore, when the thickness is 1.0 μm or more, for example, alloying of nickel or copper with sodium can be effectively prevented in a battery in which sodium is used as an electrolyte. The upper limit of the thickness is not particularly specified from this standpoint. However, from the standpoint of ensuring the porosity of the porous body as large as possible and suppressing the cost, the thickness is preferably 3.0 μm or less.

According to another embodiment of the present invention, the porous metal body may further include a tin covering layer that covers at least a part of a surface of the aluminum covering layer (Claim 5). In this case, the tin covering layer preferably has a thickness of 1.5 μm or more and 9.0 μm or less (Claim 6).

By constituting a battery including a battery electrode including the porous metal body of the present invention (Claim 7), it is possible to obtain a battery including an electrode having a very large surface area and a battery including an electrode that can hold a large amount of electrode active material owing to a three-dimensional network structure. In particular, when a tin covering layer is provided on a surface and the porous metal body is used as a negative electrode of a sodium molten-salt battery, tin can be used as an active material by being alloyed with sodium, and thus a battery having a large negative electrode capacity can be obtained (Claim 8). In this case, tin and sodium can be alloyed by conducting charging in a molten-salt battery containing sodium. Examples of a metal that can be used by being alloyed with sodium include silicon, tin, and indium. Accordingly, a similar advantage can be achieved by forming a silicon covering layer or an indium covering layer instead of the tin covering layer. Among these, tin is preferred from the standpoint of ease of handling. By forming the tin covering layer so as to have a small thickness, a battery having excellent charge-discharge characteristics can be obtained. The thickness of the tin covering layer is preferably 1.5 μm to 9.0 μm. When the thickness is less than 1.5 μm, the amount of tin serving as an active material is insufficient and it is difficult to obtain a sufficient battery capacity. When the thickness exceeds 9.0 alloying with sodium proceeds to a deep portion of the tin covering layer, resulting in degradation of the battery performance, such as a decrease in the rate of charging and discharging.

A porous metal body of the present invention can be produced by a step of preparing a skeleton body having a three-dimensional network structure and formed of a hollow metal skeleton composed of a metal layer containing nickel or copper as a main component, and a step of forming an aluminum covering layer on at least an outer surface of the metal skeleton by plating the skeleton body in a molten salt (Claim 9).

Such a skeleton body can be obtained as known Celmet or a known metal nonwoven fabric. Therefore, a porous aluminum body can be stably produced at a low cost. Furthermore, a roasting step of a resin, the roasting step being necessary for the production process of Celmet and being conducted after metal plating, is not necessary after the formation of the aluminum covering layer, and thus this method does not involve oxidation of an aluminum surface. Accordingly, a porous metal body having an aluminum surface that can be used as an electrode of a battery or the like can be obtained.

The method may further include, after the step of forming an aluminum covering layer, a step of forming a tin covering layer on at least a part of a surface of the aluminum covering layer. In this case, a porous metal body having a tin covering layer on a surface thereof can be obtained (Claim 10). The tin covering layer can be formed by a known method such as plating, vapor deposition, sputtering, or paste coating. Zinc-substitution plating may be performed on the surface of the aluminum covering layer, and tin plating may then be performed to form the tin covering layer. This method is preferable from the standpoint of improving the adhesion.

Similarly to the method for producing a known Celmet composed of nickel or copper, the skeleton body may be produced through steps of imparting electrical conductivity to a surface of a porous resin body having a three-dimensional network structure, plating the surface of the porous resin body, to which electrical conductivity has been imparted, with nickel or copper, and, after the plating, removing the porous resin body by roasting or dissolution (Claim 11).

### Advantageous Effects of Invention

As described above, according to the present invention, it is possible to obtain a porous metal body that can be used as a battery electrode, in particular, a porous metal body that can be used as a negative electrode of a molten-salt battery using sodium.

### BRIEF DESCRIPTION OF DRAWINGS

FIG. 1 is a flowchart showing steps of producing a porous metal body according to the present invention.

FIG. 2 is a flowchart showing, as a typical example of steps of producing a metal skeleton body, steps of producing a porous nickel body.

FIG. 3 is a schematic view illustrating an example of a cross-sectional structure of a porous metal body according to the present invention.

FIG. 4 is a schematic cross-sectional view illustrating a structural example in which a porous metal body is applied to a molten-salt battery.

### DESCRIPTION OF EMBODIMENTS

Embodiments of the present invention will now be described as a typical example, which includes a step of forming a tin covering layer. In the drawings referred to below, parts that are assigned the same numeral are the same or corresponding parts. Note that the present invention is not limited to the embodiments but defined by the claims, and is intended to include all modifications within the scope and meaning of equivalents of the claims.

### (Steps of Producing Porous Metal Body)

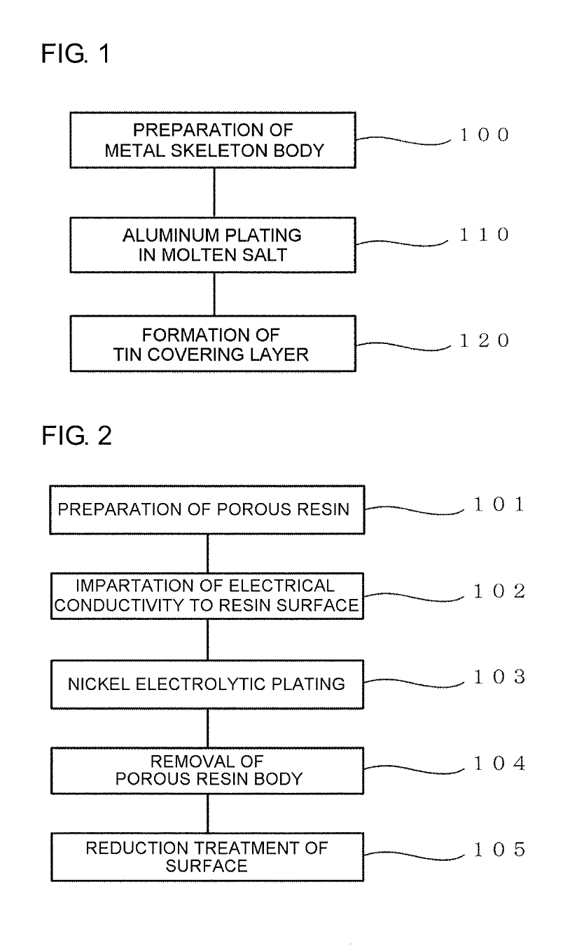

FIG. 1 is a flowchart showing steps of producing a porous metal body according to the present invention. The steps are performed in the order of preparation 100 of a metal skeleton body, aluminum plating 110 on a surface of the prepared metal skeleton body, and formation 120 of a tin covering layer on the plated aluminum surface.

FIG. 2 is a flowchart showing, as a typical example of steps of producing the metal skeleton body in FIG. 1, steps of producing a porous nickel body having a three-dimensional network structure. By replacing nickel with copper, a porous copper body can be obtained. The steps can be performed in the order of a preparation step 101 of a porous resin body such as urethane foam or melamine foam, impartation of electrical conductivity 102 to a surface of the resin by carbon coating, electroless plating, or the like on the resin surface, nickel electrolytic plating 103 on the resin surface to which electrical conductivity has been imparted, removal 104 of the resin by a method such as roasting at a high temperature, and a reduction treatment 105 of the surface oxidized in the case of roasting.

The steps shown in FIG. 1 will be sequentially described in detail. A case where nickel is used as the skeleton body will be described below. However, in the case where copper is used, a similar procedure can be performed by replacing the material.

### (Preparation of Metal Skeleton Body)

As a porous metal body serving as a skeleton body to be plated with aluminum, nickel Celmet is used. Nickel Celmet is a porous metal body in which a tubular nickel skeleton whose core portion is hollow forms a three-dimensional network structure. The nickel layer preferably has a thickness of about 4.0 to 6.0 μm, a porosity of 90% to 98%, and a pore diameter of 50 μm or more and 100 μm or less.

Note that the porosity of a porous body is defined by the following formula/Porosity

Porosity=(1−(weight of porous body [g]/(volume of porous body [cm³]×density of raw material))×100[%]

The pore diameter is determined by magnifying a surface of the porous body by means of a photomicrograph or the like, counting the number of pores per inch (25.4 mm) as a cell number, and calculating an average value as mean pore diameter=25.4 mm/cell number.

### (Formation of Aluminum Covering Layer: Molten-Salt Plating)

Next, the prepared skeleton body is immersed in a molten salt and electrolytic plating is conducted. Thus, an aluminum covering layer is formed on the surface of the nickel skeleton. A direct current is applied between the nickel skeleton serving as a cathode and an aluminum plate having a purity of 99.99% and serving as an anode in a molten salt. It is sufficient that the thickness of the aluminum covering layer is 1 μm or more. Preferably, the thickness is 1.0 μm or more and 3.0 μm or less. As the molten salt, an organic molten salt that is a eutectic salt of an organohalide and an aluminum halide or an inorganic molten salt that is a eutectic salt of an alkali metal halide and an aluminum halide can be used. Imidazolium salts, pyridinium salts, and the like can be used as the organohalide. Among these, 1-ethyl-3-methylimidazolium chloride (EMIC) and butylpyridinium chloride (BPC) are preferred. A salt containing an imidazolium cation having alkyl groups at the 1- and 3-positions is preferably used as the imidazolium salt. In particular, a molten salt of aluminum chloride and 1-ethyl-3-methylimidazolium chloride (AlCl₃-EMIC) is most preferably used because it has high stability and is not easily decomposed.

Mixing of moisture or oxygen into the molten salt degrades the molten salt. Therefore, plating is preferably conducted in an inert gas atmosphere such as nitrogen or argon in a closed environment. In the case where an EMIC bath is used as an organic molten-salt bath, the temperature of the plating bath is 10° C. to 60° C., and preferably 25° C. to 45° C.

In the case where an imidazolium salt bath is used as a molten-salt bath, an organic solvent is preferably added to the molten-salt bath. Xylene is particularly preferably used as the organic solvent. Addition of an organic solvent, in particular, xylene, achieves advantages specific to the formation of an aluminum covering layer. Specifically, it is possible to obtain a first feature that a surface of an aluminum skeleton forming a porous body is smooth and a second feature that uniform plating can be performed in which a difference in plating thickness between a surface portion and an inner portion of the porous body is small. The first feature is due to the fact that the addition of an organic solvent improves the shape of plating on the skeleton surface from a granular state (which is significantly uneven and appears to be granules in surface observation) to a flat shape, thereby increasing the strength of the skeleton having a small thickness and a small width. The second feature is due to the fact that the addition of an organic solvent to a molten-salt bath decreases the viscosity of the molten-salt bath and thus the plating bath easily passes through the inner portion of the fine network structure. More specifically, when the viscosity is high, a fresh plating bath is easily supplied to the surface of the porous body, but is not easily supplied to the inner portion. In contrast, by decreasing the viscosity, the plating bath is easily supplied to the inner portion, and thus plating that provides a film having a uniform thickness can be performed.

Owing to these two features, for example, when a completed porous metal body is pressed, it is possible to obtain a porous body whose aluminum covering layer on the skeleton surface is not easily broken as a whole and which is evenly pressed. When a porous metal body is used as an electrode material of a battery or the like, the electrode is filled with an electrode active material and is then pressed in order to increase the density. The skeleton is easily broken in this step of filling the electrode with the active material and during pressing. Therefore, the addition of an organic solvent is very effective in such an application.

In order to obtain the above features, the amount of organic solvent added to the plating bath is preferably 25% to 57% by mole. When the amount of organic solvent is 25% by mole or less, it is difficult to achieve the effect of reducing the difference in plating thickness between a surface portion and an inner portion. When the amount of organic solvent is 57% by mole or more, the plating bath becomes unstable and a plating solution and xylene are partially separated from each other.

Furthermore, subsequent to the step of conducting plating in the molten-salt bath containing an organic solvent, a washing step in which the organic solvent is used as a washing liquid is preferably further performed. It is necessary to wash a surface of a plated skeleton in order to wash away a plating solution. Such washing after plating is usually performed with water. However, it is essential that moisture be avoided in an imidazolium salt bath. If washing is performed with water, water is taken in the plating solution in the form of water vapor or the like. Accordingly, washing with an organic solvent is effective. Furthermore, in the case where an organic solvent is added to a plating bath as described above, a more advantageous effect can be obtained by conducting washing with the organic solvent added to the plating bath. Specifically, the plating solution after washing can be relatively easily recovered and reused, and the cost can be reduced. For example, it is supposed that a plating solution adhering to a plated skeleton formed in a bath prepared by adding xylene to a molten salt AlCl₃-EMIC is washed with xylene. The resulting liquid after washing is a liquid that contains xylene in an amount larger than the amount of xylene contained in the plating bath that is originally used. A certain amount or more of the molten salt AlCl₃-EMIC is not mixed with xylene. Thus, the liquid after washing is separated into xylene on the upper side and the molten salt AlCl₃-EMIC containing about 57% by mole of xylene on the lower side. Therefore, the molten salt can be recovered by collecting the separated liquid on the lower side. Furthermore, since the boiling point of xylene is as low as 144° C., the xylene concentration in the recovered molten salt is adjusted to the xylene concentration in the plating solution by applying heat, and the recovered molten salt can be reused. After the washing with an organic solvent, it is also preferable to further conduct washing with water in another place that is separated from the plating bath.

### (Formation of Tin Covering Layer)

Furthermore, in order to obtain a porous body suitable as a negative electrode of a sodium molten-salt battery, a tin covering layer is formed on the surface. A tin plating step will be described as a typical example.

Tin plating can be performed by electroplating in which tin is electrochemically deposited on a surface of an aluminum covering layer of a skeleton body or electroless plating in which tin is chemically reduced and deposited on a surface of an aluminum covering layer of a skeleton body.

First, as a pretreatment, a soft etching treatment for removing an oxidized film on an aluminum covering layer with an alkaline etchant is conducted. Next, a dissolved residue-removal treatment is conducted using nitric acid. After water washing, a zincate treatment (zinc-substitution plating) is conducted on the surface of the aluminum covering layer, from which the oxidized film has been removed, using a zincate treatment solution to form a zinc film. At this time, a removal treatment of the zinc film may be conducted once, and the zincate treatment may be conducted again. In this case, a zinc film having a higher density and a smaller thickness can be formed, the adhesion with the aluminum covering layer improves, and thus dissolution of zinc can be suppressed.

Next, the skeleton having the zinc film thereon is immersed in a plating bath into which a plating solution is poured, and tin plating is conducted to form a tin plating film. An example of the plating bath is described below.

Composition of Plating Solution

SnSO₄: 40 g/dm³

H₂SO₄: 100 g/dm³

Cresolsulphonic acid: 50 g/dm³

Formaldehyde (37%): 5 mL/dm³

Gloss agent

pH: 4.8

Temperature: 20° C. to 30° C.

Current density: 2 A/dm²

Anode: Sn

Prior to the formation of a tin plating film, a nickel plating film may be formed on the zinc film. An example of a plating bath in the case of forming a nickel plating film is described below.

Composition of Plating Solution

Nickel sulphate: 240 g/L

Nickel chloride: 45 g/L

Boric acid: 30 g/L

pH: 4.5

Temperature: 50° C.

Current density: 3 A/dm²

By forming this nickel plating film as an interlayer, an acidic or alkaline plating solution can be used in conducting tin plating. If an acidic or alkaline plating solution is used without forming a nickel plating film, zinc is dissolved in the plating solution.

When the porous body is used as an electrode of a sodium molten-salt battery, it is preferable to consider the following points:

First, in the tin plating step described above, the tin plating film is preferably formed so as to have a thickness of 0.5 μm or more and 600 μm or less. The film thickness is adjusted by controlling the immersion time in the plating solution, etc. When the film thickness is 0.5 μm or more and 600 μm or less and the porous body is used as a negative electrode, a desired electrode capacity can be obtained and it is possible to suppress, for example, short circuit caused by breaking of the tin plating film due to expansion by a volume change. The film thickness is more preferably 0.5 μm or more and 400 μm or less because breaking is more reliably suppressed. The film thickness is still more preferably 0.5 μm or more and 100 μm or less from the standpoint of improving the capacity maintenance rate of charging and discharging. Furthermore, from the standpoint of suppressing a decrease in the discharge voltage, improvement of the capacity maintenance rate, and the effect of increasing a surface hardness, the film thickness is particularly preferably 1.5 μm or more and 9.0 μm or less.

In the tin plating step, the tin plating film is preferably formed so as to have a crystal grain size of 1 μm or less. The crystal grain size is adjusted by controlling the conditions such as the composition and temperature of the plating solution, etc. In the case where the crystal grain size is 1 μm or less, it is possible to suppress a reduction in the charging/discharging cycle lifetime due to an increase in a volume change when the tin plating film stores sodium ions.

Furthermore, in the plating step, the tin plating film is preferably formed so that the ratio of a difference between the maximum or the minimum and an average of the thickness of the film to the average is 20% or less. When the ratio is 20% or less, it is possible to suppress the degradation of the charging/discharging cycle lifetime due to an increase in the variation in the depth of charging/discharging in the case where the planar area of the negative electrode is increased. In addition, it is also possible to suppress short circuit due to the formation of sodium dendrites in a portion where the depth is locally large. For example, when the average of the thickness of a tin plating film is 10 μm, the film thickness is preferably in the range of 10 μm±2 μm. When the average of the film thickness is 600 μm, the film thickness is preferably in the range of 600 μm±120 μm.

A zinc diffusion step of causing zinc to diffuse to the aluminum covering layer side is preferably performed as an additional treatment. An example of this zinc diffusion step is heat treatment at a temperature of 200° C. or higher and 400° C. or lower for about 30 seconds to 5 minutes. The treatment temperature may be increased to 400° C. or higher depending on the thickness of the zinc film. Alternatively, zinc may be caused to diffuse to the aluminum covering layer side by applying a potential difference between the aluminum covering layer side and the surface side of the porous metal body having the tin covering layer thereon. This zinc diffusion step may not be performed. However, when this heat treatment is performed, zinc can be caused to diffuse to the base side, and thus the formation of dendrites is suppressed and safety can be improved.

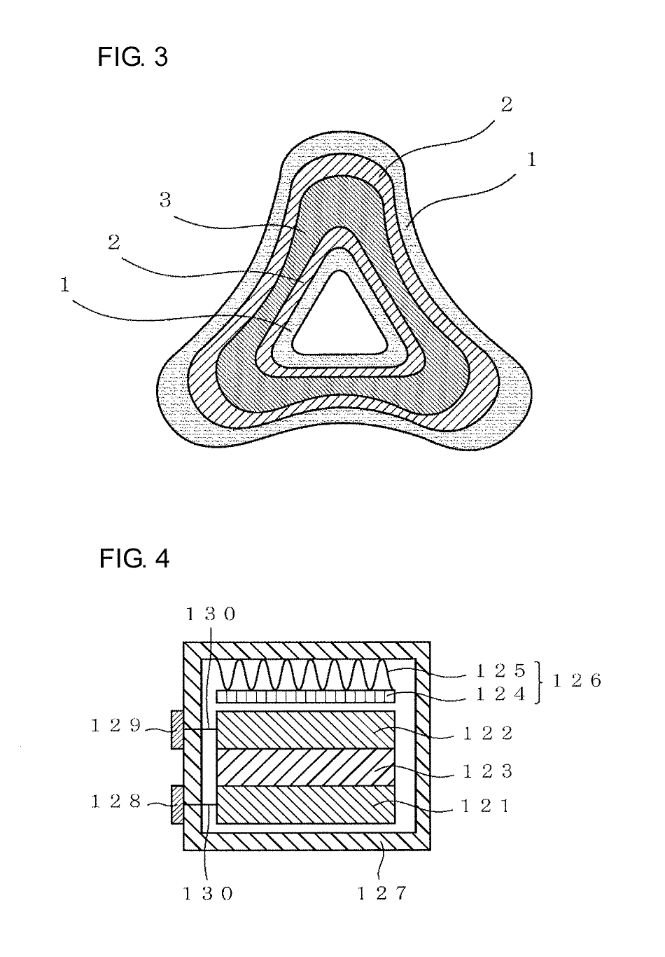

FIG. 3 schematically illustrates an example of a cross section of a skeleton of a porous metal body produced as described above. An aluminum covering layer 2 is formed on each of the outer surface and the inner surface of a nickel layer 3 serving as a metal skeleton, and a tin covering layer 1 is further formed on each of the surfaces of the aluminum covering layers 2. The skeleton has a hollow inner portion, and this hollow skeleton constitutes a three-dimensional network structure to form a porous metal body having continuous pores.

### (Molten-Salt Battery)

A description will be made of a structure in which a porous metal body of the present invention is used as an electrode material for a molten-salt battery. When a porous aluminum body is used as a positive-electrode material, a metal compound that can intercalate a cation of a molten salt serving as an electrolyte, for example, sodium chromate (NaCrO₂) or titanium disulfide (TiS₂), is used as an active material. The active material is used in combination with a conductive aid and a binder. Acetylene black and the like can be used as the conductive aid. Polytetrafluoroethylene (PTFE) and the like can be used as the binder. When sodium chromate is used as the active material and acetylene black is used as the conductive aid, PTFE is preferred because it can more firmly bond these two substances to each other.

A porous metal body of the present invention can be used as a negative-electrode material of a motel-salt battery. Elemental sodium, an alloy of sodium and another metal, carbon, or the like can be used as an active material. Since the melting point of sodium is about 98° C. and the metal softens with an increase in the temperature, sodium is preferably alloyed with another metal (such as Si, Sn, or In). Among these, an alloy of sodium and tin is particularly preferable because the alloy is easy to handle. Therefore, a porous metal body in which a tin covering layer is provided on a surface of aluminum is preferably used. Tin and sodium are alloyed by charging a negative electrode including a tin covering layer in the molten-salt battery, and the resulting alloy can be used as an active material. In particular, in a porous metal body in which a tin covering layer is provided on each of the outer surface and the inner surface of a metal skeleton, the amount of active material and the surface area can be increased as compared with a case where a tin covering layer is provided only on the outer surface. Thus, such a porous metal body can contribute to the realization of a battery having a large capacity.

FIG. 4 is a schematic cross-sectional view illustrating an example of a molten-salt battery that uses the above-described electrode material for a battery. The molten-salt battery includes a positive electrode 121 in which a positive electrode active material is supported on the surface of a porous metal body having a surface layer composed of aluminum, a negative electrode 122 that includes a porous metal body further including a tin covering layer on the surface thereof, and a separator 123 impregnated with a molten salt serving as an electrolyte. The positive electrode 121, the negative electrode 122, and the separator 123 are housed in a case 127. A pressing member 126 including a pressing plate 124 and a spring 125 that presses the pressing plate is arranged between the upper surface of the case 127 and the negative electrode. Since the pressing member is provided, even when the positive electrode 121, the negative electrode 122, and the separator 123 are subjected to volume changes, all the components can be uniformly pressed and brought into contact with each other. A collector of the positive electrode 121 and a collector of the negative electrode 122 are respectively connected to a positive electrode terminal 128 and a negative electrode terminal 129 through lead wires 130. In this embodiment, since nickel or copper is used as a main component of the skeleton of the porous metal body, the strength of the skeleton can be maintained to be high. In particular, when the skeleton is composed of copper, the electrical resistance of the electrode can be made extremely low, and thus higher battery characteristics can be obtained.

Various inorganic salts or organic salts that melt at an operating temperature can be used as the molten salt serving as an electrolyte. At least one selected from alkali metals such as lithium (Li), sodium (Na), potassium (K), rubidium (Rb), and cesium (Cs) and alkaline earth metals such as beryllium (Be), magnesium (Mg), calcium (Ca), strontium (Sr), and barium (Ba) can be used as the cation of the molten salt. In order to decrease the melting point of the molten salt, two or more salts are preferably used as a mixture. For example, when potassium bis(fluorosulfonyl)amide (KFSA) and sodium bis(fluorosulfonyl)amide (NaFSA) are used in combination, the operating temperature of the battery can be controlled to be 90° C. or lower. The molten salt is used by impregnating the separator. The separator is provided in order to prevent the positive electrode and the negative electrode from contacting each other. A glass nonwoven fabric, a porous resin, and the like can be used as the separator. The positive electrode, the negative electrode, and the separator impregnated with the molten salt are stacked, housed in the case, and used as a battery.

### EXAMPLES

A production example of a porous aluminum body will be specifically described below. A nickel Celmet having a thickness of 1 mm, a porosity of 95%, and a number of pores (cell number) per inch of about 50 was prepared as a Celmet serving as a skeleton body and cut into a 140 mm×340 mm piece. Since the thickness of an aluminum covering layer and the thickness of a tin covering layer are smaller than the thickness of the skeleton body, the porosity of the porous body after the formation of these covering layers is substantially the same as the porosity of the skeleton body, i.e., 95%.

### (Formation of Aluminum Covering Layer)

The nickel Celmet was set to a fixture having a power-supplying function, and then immersed in a molten salt aluminum plating bath (17 mol % EMIC-34 mol % AlCl₃-49 mol % xylene) at a temperature of 40° C. The fixture to which the nickel Celmet was set was connected to the cathode side of a rectifier and an aluminum plate (purity: 99.99%) serving as a counter electrode was connected to the anode side. A direct current having a current density of 3.6 A/dm² was applied for 60 minutes to perform aluminum plating. Stirring was conducted with a stirrer using a Teflon (registered trademark) rotor. Note that the apparent area of the porous aluminum body is used in the calculation of the current density (the actual surface area of the nickel Celmet is about 8 times the apparent area). As a result, an aluminum plating film having a weight of 120 g/m² and a thickness of 5.0 μm could be substantially uniformly formed.

### (Formation of Tin Covering Layer)

As a pretreatment, a soft etching treatment for removing an oxidized film on a surface of the aluminum covering layer with an alkaline etchant was conducted. Next, a dissolved residue-removal treatment was conducted using nitric acid. After water washing, a zincate treatment (zinc-substitution plating) was conducted using a zincate treatment solution to form a zinc film. Furthermore, a removal treatment of the zinc film was conducted once, and the zincate treatment was conducted again.

Next, a nickel plating film was formed on the zinc film by plating under the following conditions:

Composition of Plating Solution

Nickel sulphate: 240 g/L

Nickel chloride: 45 g/L

Boric acid: 30 g/L

pH: 4.5

Temperature: 50° C.

Current density: 3 A/dm²

Treatment time: 330 seconds (in the case of a film thickness of about 3 μm)

The skeleton body which had been subjected to a pretreatment was immersed in a plating bath to perform tin plating. Thus, a tin plating film having a substantially uniform thickness of 3.5 μM was formed. The conditions are as follows:

Composition of Plating Solution

SnSO₄: 40 g/dm³

H₂SO₄: 100 g/dm³

Cresolsulphonic acid: 50 g/dm³

Formaldehyde (37%): 5 mL/dm³

Gloss agent

pH: 4.8

Temperature: 20° C. to 30° C.

Current density: 2 A/dm²

Anode: Sn

Treatment time: 300 seconds

### REFERENCE SIGNS LIST

1 tin covering layer, 2 aluminum covering layer, 3 nickel layer, 121 positive electrode, 122 negative electrode, 123 separator, 124 pressing plate, 125 spring, 126 pressing member, 127 case, 128 positive electrode terminal, 129 negative electrode terminal, 130 lead wire

1. A porous metal body comprising a hollow metal skeleton composed of a metal layer containing nickel or copper as a main component and having a thickness of 4.0 μm or more; and an aluminum covering layer that covers at least an outer surface of the metal skeleton.

2. The porous metal body according to claim 1, wherein the porous metal body has continuous pores due to the skeleton having a three-dimensional network structure, and a porosity of 90% or more.

3. The porous metal body according to claim 1, wherein the aluminum covering layer is provided on an inner surface of the hollow metal skeleton.

4. The porous metal body according to claim 1, wherein the aluminum covering layer has a thickness of 1.0 μm or more and 3.0 μm or less.

5. The porous metal body according to claim 1, further comprising a tin covering layer that covers at least a part of a surface of the aluminum covering layer.

6. The porous metal body according to claim 5, wherein the tin covering layer has a thickness of 1.5 μm or more and 9.0 μm or less.

7. A battery comprising an electrode including the porous metal body according to claim 1.

8. A sodium molten-salt battery comprising a negative electrode including the porous metal body according to claim 5.

9. A method for producing a porous metal body comprising a step of preparing a skeleton body having a three-dimensional network structure and formed of a hollow metal skeleton composed of a metal layer containing nickel or copper as a main component; and a step of forming an aluminum covering layer on at least an outer surface of the metal skeleton by plating the skeleton body in a molten salt.

10. The method for producing a porous metal body according to claim 9, further comprising, after the step of forming an aluminum covering layer, a step of forming a tin covering layer on at least a part of a surface of the aluminum covering layer.

11. The method for producing a porous metal body according to claim 9, wherein the skeleton body is produced through steps of imparting electrical conductivity to a surface of a porous resin body having a three-dimensional network structure, plating the surface of the porous resin body, to which electrical conductivity has been imparted, with nickel or copper, and, after the plating, removing the porous resin body by roasting or dissolution.
